(19) United States
(12) Patent Application Publication
(10) Pub. No.: US 2018/0282214 A1
(43) Pub. Date: Oct. 4, 2018

(54) Compositions and Methods for Cementing Wells

(71) Applicant: Schlumberger Technology Corporation, Sugar Land, TX (US)

(72) Inventors: Changsheng Xiang, Houston, TX (US); Mohan Kanaka Raju Panga, Sugar Land, TX (US)

(21) Appl. No.: 15/478,914

(22) Filed: Apr. 4, 2017

(51) Int. Cl. C04B 22/06; C04B 28/02; C04B 24/04; C04B 38/10; C09K 8/473; E21B 33/13

(52) U.S. Cl. CPC C04B 22/06; C04B 28/02; C04B 24/04; C04B 2103/408; C09K 8/473; E21B 33/13; C04B 38/10

(57) ABSTRACT

A cement composition including an aqueous fluid, inorganic cement, a foaming agent, a gas generating agent, and a stabilizer composition comprising graphene oxide. The cement composition is placed in a subterranean well and allowed to set and form a set cement. The presence of the graphene oxide results in the set cement having a greatest percent deviation from a measured slurry density of less than about 1.5%.

### BACKGROUND OF THE DISCLOSURE

The statements in this section merely provide background information related to the present disclosure and may not constitute prior art.

This disclosure relates to compositions and methods for improving the performance of energized cement systems for well cementing applications.

Primary cementing is the process of placing cement in the annulus between the casing and the formations exposed to wellbore. Alternatively, cement may be placed in the annular region between two casing strings. The major objective of primary cementing is to provide zonal isolation in wells; for example, to exclude fluids such as water or gas in one zone from oil in another zone in the well, or to protect aquifers from contamination by oil or gas emanating from zones further downhole. To achieve this objective, a hydraulic seal is created between the casing and cement and between the cement and the formations, while at the same time preventing the formation of fluid channels within the cement sheath.

The basic process for accomplishing a primary cementing job employs the two-plug method for pumping and displacement. After the well is drilled to the desired depth, the drill pipe is removed and a larger-diameter casing string is normally run to the bottom of the well. At this time, drilling mud remains in the wellbore. This mud is then displaced, removed from the well and replaced by a cement slurry. To prevent contamination by mud, two plugs isolate the cement slurry as it is pumped down the casing. Sufficient cement slurry is pumped into the casing to fill the annular space from the bottom to at least a level that covers the productive zones. In addition to providing zonal isolation, the cement sheath in the annulus protects the casing from corrosion. After slurry placement, the well is shut in for a time sufficient to allow the cement to harden before completion work begins or drilling commences to a deeper horizon.

Remedial cementing includes two broad categories: squeeze cementing and plug cementing. Squeeze cementing is the process of placing a cement slurry into a wellbore under sufficient hydraulic pressure to partially dehydrate or expel water from the cement slurry, leaving a competent cement that will harden and seal voids. Plug cementing is the placement of a limited volume of cement at a specific location inside the wellbore to create a solid seal or plug. Remedial cementing operations are performed for various reasons: to repair faulty primary cementing jobs, alter formation characteristics, repair casing and abandon wells.

For primary or remedial cementing to be successful, the cement should bond with the surfaces to which it is attached—casing or formation rock. Numerous techniques have been developed to achieve good bonding. For example, actions may be undertaken to ensure that the drilling fluid is efficiently removed from the annulus, ensuring that the bonding surfaces are clean and water-wet. Another technique is the addition of latexes to the cement slurry to improve adhesion of the cement to the casing and formation.

Another method for achieving improved bonding is to “energize” or “form” the cement slurry by generating gas inside the slurry in situ during placement and the setting phase. Such slurries are compressible and the resulting pressurization may ensure optimal contact between the slurry and the bonding surfaces. The presence of gas in a cement slurry may also improve fluid-loss control and help prevent migration of formation fluids into the annulus before the cement sets.

A thorough description of the primary and remedial cementing, as well as methods for improving bonding, may be found in the following publication. Nelson E B and Guillot D (eds.): Well Cementing—2nd Edition, Houston: Schlumberger (2006).

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces a method including preparing a cement composition containing an aqueous fluid, inorganic cement, a foaming agent, a gas generating agent, and a stabilizer composition containing graphene oxide. The method also includes placing the cement composition in a subterranean well, and allowing the composition to set and form a set cement. The presence of the graphene oxide results in the set cement having a greatest percent deviation from a measured slurry density of less than about 1.5%.

The present disclosure also introduces a cement composition containing aqueous fluid, inorganic cement, a foaming agent, a gas generating agent, and a stabilizer composition containing graphene oxide.

The present disclosure also introduces a method including preparing a mixture containing an aqueous fluid, inorganic cement, a foaming agent, a gas generating agent, and a stabilizer composition containing graphene oxide. The method also includes shearing the mixture until the slurry is homogeneous, thereby forming a cement slurry.

These and additional aspects of the present disclosure are set forth in the description that follows, and/or may be learned by a person having ordinary skill in the art by reading the material herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIGS. 1-4 are photographs according to at least a portion of an example implementation according to one or more aspects of the present disclosure.

FIG. 5 is a photograph of the form half-life test according to at least a portion of an example implementation according to one or more aspects of the present disclosure.

FIG. 6 is a graph of the form half-life results for various concentrations of graphene oxide in deionized water according to at least a portion of an example implementation according to one or more aspects of the present disclosure.

FIG. 7 is a photograph of the form volume test according to at least a portion of an example implementation according to one or more aspects of the present disclosure.

FIG. 8 is a graph of the form volume results for various concentrations of graphene oxide in deionized water according to at least a portion of an example implementation according to one or more aspects of the present disclosure.

FIG. 9 is a photograph of the form half-life test according to at least a portion of an example implementation according to one or more aspects of the present disclosure.

FIG. 10 is a graph of the form half-life results for various concentrations of graphene oxide in seawater according to at least a portion of an example implementation according to one or more aspects of the present disclosure.

FIG. 11 is a photograph of the form volume test according to at least a portion of an example implementation according to one or more aspects of the present disclosure.

FIG. 12 is a graph of the form volume results for various concentrations of graphene oxide in seawater according to at least a portion of an example implementation according to one or more aspects of the present disclosure.

FIG. 13 is a photograph of the form half-life test according to at least a portion of an example implementation according to one or more aspects of the present disclosure.

FIG. 14 is a graph of the form half-life results for various concentrations of graphene oxide in seawater according to at least a portion of an example implementation according to one or more aspects of the present disclosure.

FIG. 15 is a photograph of the form volume test according to at least a portion of an example implementation according to one or more aspects of the present disclosure.

FIG. 16 is a graph of the form volume results for various concentrations of graphene oxide in seawater according to at least a portion of an example implementation according to one or more aspects of the present disclosure.

FIGS. 17-19 are microscopic images according to one more aspects of the present disclosure.

FIGS. 20-22 are graphs of the pore size distribution of the formed cement samples according to one more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. The term about should be understood as any amount or range within 10% of the recited amount or range (for example, a range from about 1 to about 10 encompasses a range from 0.9 to 11). Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

As discussed above, described herein is a method for cementing a subterranean well, the method includes preparing a cement slurry composition comprising water, inorganic cement, a gas generating agent and a stabilizer composition comprising graphene oxide. The cement slurry composition is then placed in the subterranean well and allowed to set and form a set cement. For the reasons discussed in greater detail below, the presence of the graphene oxide in the stabilizer composition results in a set cement having a greatest percent deviation from a measure slurry density of less than about 1.5%.

“Formed” or “energized” cement may be used in subterranean well construction where low density and sufficient compressive strength are factors. Formed cement may also (1) reduce the density of the cement, (2) increase compressive strength and (3) improve permeability such that long term zonal isolation may be realized; thus preventing hydrostatic pressure damage. In addition, formed cement may also possess sufficient flexibility such that the set cement is both compressible and expandable, which allow it to flex or absorb stress that could often collapse conventional cements.

Graphene Oxide Stabilizer

As discussed above, the stabilizer composition includes graphene oxide (GO), which is derived from graphene. Graphene is an atomic-scale hexagonal lattice comprised of carbon atoms. It is a two-dimensional sheet one carbon atom thick that is 100 times stronger than steel, and more conductive than copper.

As a derivative of graphene, graphene oxide (GO) can be mass produced through the oxidation of graphite. Graphene oxide (GO) is a family of impure oxidized forms of graphene that includes hydroxyl and epoxide groups bonded to various carbon atoms in the lattice matrix. Although the structure of GO has been studied, the exact chemical structure (at least in terms of hydroxyl and epoxide group frequency) remains the subject of debate within the scientific community. GO may also include carboxylic acid groups believed to be located at the edges of the carbon sheets. The wide variety of functional groups allow GO to be further functionalized.

The initial process for forming GO included the treatment of graphite with potassium chlorate and fuming nitric acid. A slightly more efficient process was then developed that employs sulfuric acid, sodium nitrate, and potassium permanganate to convert graphite to graphene oxide. An even more efficient process was recently developed (2010) employing sulfuric acid, phosphoric acid, and potassium permanganate.

GO is also water soluble, which makes the application of GO even broader that graphene. The length of graphene oxide may range from about 1 micron to 100 micron, such as, for example, from about 1 micron to about 10 microns, and thickness of about 0.8 nm.

The graphene oxide in the cement composition may be present at a concentration between about 0.001% and about 1% BWOC (by weight of cement), about 0.02% and about 0.5% BWOC, and about 0.05% about 0.1% BWOC.

As discussed in greater detail below, the inclusion of the graphene oxide in the formed cement slurry results in the set cement having a greatest percent deviation from a measured slurry density of less than about 1.5%, such as, for example less than about 1.25%, less than about 1.0% and less than about 0.5%. Furthermore, graphene oxide further increases form volume and form half-life by at least 20%.

The stabilizer composition may include one or more additional stabilizers, in addition to the graphene oxide. Examples of additional stabilizers include polyglycols, oxyalkylates, nanocrystalline cellulose, nanofibrillated cellulose, viscosifies, such as diutan, Welan gum, guar gum, and hydroxethyl cellulose polymers, and combinations thereof. If present, the one or more additional stabilizers may be present at an amount of about 0.01 wt % to about 0.5 wt %, and from about 0.05 wt % to about 0.2 wt %.

Aqueous Fluid

The aqueous fluid may be selected from the group including fresh water, seawater, a brine containing organic and/or inorganic dissolved salts, liquids containing water-miscible organic compounds and combinations thereof. For example, the aqueous fluid may be formulated with mixtures of desired salts in fresh water. Such salts may include, but are not limited to alkali metal chlorides, hydroxides, or carboxylates. In various embodiments, the brine may include seawater, aqueous solutions wherein the salt concentration is less than that of seawater, or aqueous solutions wherein the salt concentration is greater than that of seawater. Salts that may be found in seawater include, but are not limited to, sodium, calcium, aluminum, magnesium, potassium, strontium, and lithium, salts of chlorides, bromides, carbonates, iodides, chlorates, bromates, formates, nitrates, oxides, phosphates, sulfates, silicates, and fluorides. Salts that may be incorporated in a given brine include any one or more of those present in natural seawater or any other organic or inorganic dissolved salts.

Additionally, brines that may be used in the wellbore fluids disclosed herein may be natural or synthetic, with synthetic brines tending to be much simpler in constitution. In one embodiment, the density of the wellbore fluid may also be controlled by increasing the salt concentration in the brine (up to saturation). In a particular embodiment, a brine may include halide or carboxylate salts of mono- or divalent cations of metals, such as cesium, potassium, calcium, zinc, and/or sodium. Specific examples of such salts include, but are not limited to, NaCl, CaCl₂, NaBr, CaBr₂, ZnBr₂, NaHCO₂, KHCO₂, KCl, NH₄Cl, CsHCO₂, MgCl₂, MgBr₂, KH₃C₂O₂, KBr, NaH₃C₂O₂ and combinations thereof.

As discussed above, the aqueous fluid may be a brine, such as seawater, which may include a dispersant. Suitable examples of dispersants include, but are not limited to acrylic acid, sodium polynaphthalene sulfonate, polycarboxylate polymers, and combinations thereof. The dispersant may be present in an amount of from about from about 0.05 gal/sk (4.43 mL/kg) to about 0.75 gal/sk (66.53 mL/kg), from about 0.1 gal/sk (8.87 ml/kg) to about 0.5 gal/sk (44.35 mL/kg) and from about 0.2 gal/sk (17.74 mL/kg) to about 0.4 gal/sk (35.48 mL/kg).

Inorganic Cement

The cement composition may further include inorganic cement. The inorganic cement may comprise Portland cements, calcium aluminum cements, fly ashes, lime-silica mixtures, cement kiln dust, magnesium oxychloride, zeolites, blast furnace slags, geopolymers or chemically bonded phosphate ceramics or cations thereof.

Forming Agent

The cement composition may further include a foaming agent (also referred to herein as a former). Examples of suitable forming agents may include an alkali salt of an alkyl ether sulfate and/or an alkyl sulfate; a mixture of isopropanol, butan-1-ol, 2-Butoxyethanol, sodium chloride, water, cocamidopropyl betaine and cocamidopropylamine oxide, or a mixture of ethanol, ethylene glycol, 2-butoxyethanol, water, ammonium C6-C10 alcohol ethoxysulfate, alcohols, and C6-C10 ethoxylated, or a mixture of isopropanol, water, amphoteric alkyl amine, or linear alcohol sulfonate, or toluene sulfonate, or olefin sulfonate, or sodium lauryl ether sulfate, or sodium lauryl sulfate, or ammonium lauryl sulfate.

The former may be present in an amount of from about from about 0.05 gal/sk (4.43 mL/kg) to about 0.75 gal/sk (66.53 mL/kg), from about 0.1 gal/sk (8.87 ml/kg) to about 0.5 gal/sk (44.35 mL/kg) and from about 0.2 gal/sk (17.74 mL/kg) to about 0.4 gal/sk (35.48 mL/kg). [Inventors—Please confirm this range is acceptable]

Gas Generating Agent

Controlling the form stability of formed cement slurry ensures that any gas present in the formed cement will not escape or coalesce into larger bubbles and form gas pockets. These gas pockets may result in un-cemented sections or channels in the annular space, which can lead to weak compressive strength and high gas permeation of the cement.

The cement slurry further includes a gas generating agent (also referred to as a foaming agent). As defined herein, the phrase “gas generating agent” includes both inert gases and materials that once exposed to the conditions of the subterranean formation release a gas. Inert gases, such as nitrogen do not react with cement and the amount of gas injected into the cement slurry depends on the desired form density. Formed cement slurry may be categorized by form quality (FQ), which is the ratio of the gas to the total volume of the cement slurry. FQ ranges from 16% to 25% for conventional formed cement. However, the FQ may increase to about 30% or about 35% depending on the type of formation as indicated below (See Example 3-30%).

The gas generating agent may be one or more inert gases or one or more materials release one or more gases. Specifically, the gas generating agent may comprise aluminum or zinc or a combination thereof. The gas generating agent may release carbon dioxide and may comprise ethylene carbonate or oxalic acid derivatives or combinations thereof. The gas generating agent may release nitrogen gas and may comprise azodicarbonamide, oxy-bis-benzene sulfonylhydrazide, toluenesulfonyl-hydrazide, benzenesulfonyl-hydrazide, toluenesulfonyl-semicarbazide, 5-phenyltetrazole, ammonium nitrite, diazoaminobenzene, 2,2′-asobixisobutyronitrile, 1,1′-azobiscyclohexanecarbonitrile, hydrazine salts or N—N′-dimethyl-N,N′-dinitrosoterephthalamide, ammonium C6-C10 alcohol ethoxysulfates or combinations thereof. The gas generating may be a combination of the aforementioned materials, thereby releasing more than one type of gas.

The gas generating agent may be present at a concentration from about 0.05 gal/sk (4.43 mL/kg) to about 0.75 gal/sk (66.53 mL/kg), from about 0.1 gal/sk (8.87 ml/kg) to about 0.5 gal/sk (44.35 mL/kg) and from about 0.2 gal/sk (17.74 mL/kg) to about 0.4 gal/sk (35.48 mL/kg).

Additional Materials

The composition may further comprise other additives including accelerators, retarders, dispersants, fibers, flexible particles, fluid-loss additives, gas-migration additives, extenders, expanding agents, anti-settling additives or antifoam additives or weighting agents or combinations thereof. Those skilled in the art will recognize that cenospheres, glass bubbles and the like fall within the category of extenders. Those skilled in the art will also recognize that such hollow spheres should be chosen such that they can withstand the pressures exerted not solely by gas generation but also the hydrostatic pressure in the well.

The cement composition may comprise an extender as discussed above. Examples of suitable extenders include sodium silicate, oxide glass, fly ash, non-crystalline silica and combinations thereof. The extender may be present at a concentration from about 0.05 gal/sk (4.43 mL/kg) to about 0.75 gal/sk (66.53 mL/kg), from about 0.1 gal/sk (8.87 ml/kg) to about 0.5 gal/sk (44.35 mL/kg) and from about 0.2 gal/sk (17.74 mL/kg) to about 0.4 gal/sk (35.48 mL/kg).

The cement composition may comprise a fluid loss additive as discussed above. Examples of suitable fluid loss additive include polyvinyl alcohol, hydroxyethyl cellulose, AMPS/acrylamide copolymer and combinations thereof. The extender may be present at a concentration from about 0.05 gal/sk (4.43 mL/kg) to about 0.75 gal/sk (66.53 mL/kg), from about 0.1 gal/sk (8.87 ml/kg) to about 0.5 gal/sk (44.35 mL/kg) and from about 0.2 gal/sk (17.74 mL/kg) to about 0.4 gal/sk (35.48 mL/kg).

The cement composition may be sheared until the mixture is homogeneous. The term “shear” refers to the exertion of a force (or energy), such as in the form of shear flow, applied to a pumpable and/or flowable treatment fluid (or treatment fluid system including a mixture of two or more treatment fluids) resulting in shearing deformation. In some embodiments, the pumpable and/or flowable treatment fluid may have any suitable viscosity, such as a viscosity of from about 1 cP to about 10,000 cP (such as from about 10 cP to about 1000 cP, or from about 10 cP to about 100 cP) at the treating temperature, which may range from a surface temperature to a bottom-hole static (reservoir) temperature, such as from about −40° C. to about 150° C., or from about 10° C. to about 120° C., or from about 25° C. to about 100° C., and a shear rate (for the definition of shear rate reference is made to, for example, Introduction to Rheology, Barnes, H.; Hutton, J. F; Walters, K. Elsevier, 1989, the disclosure of which is herein incorporated by reference in its entirety), during the application of a shear event, in a range of from about 1 s⁻¹ to about 100,000 s⁻¹, such as a shear rate in a range of from about 100 s⁻¹ to about 10,000 s⁻¹, or a shear rate in a range of from about 500 s⁻¹ to about 5,000 s⁻¹ as measured by common methods, such as those described in textbooks on rheology, including, for example, Rheology: Principles, Measurements and Applications, Macosko, C. W., VCH Publishers, Inc. 1994, the disclosure of which is herein incorporated by reference in its entirety.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

### EXAMPLES

### Example 1

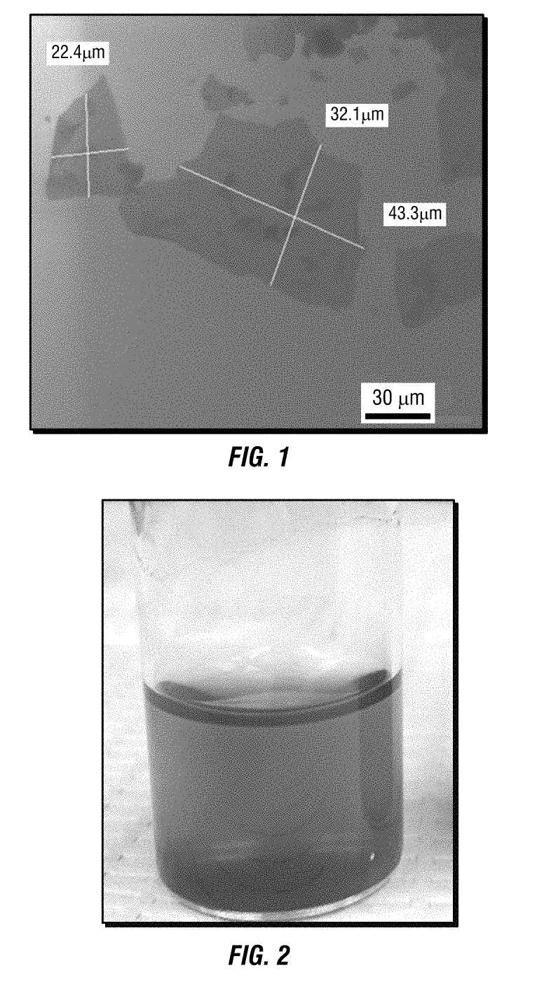

Graphene oxide (GO) may be synthesized through the oxidation of graphite flake using one or more of a concentrated sulfuric acid, phosphoric acid and potassium permanganate solution at around 50° C. for 24 hours. GO can be dispersed in deionized water (DI) due to the presence of a large amount of oxygen functional groups (—OH, —COOH, —CO) on GO. FIG. 1 and FIG. 2 shows the scanning electron microscope (SEM) image of GO and its solubility in DI water.

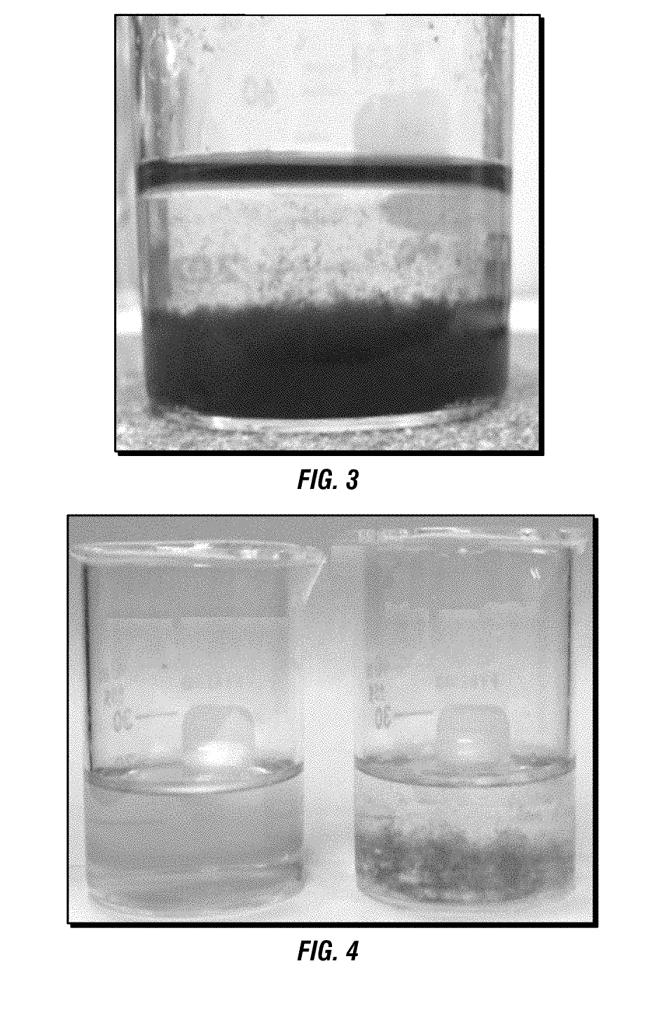

However, the dispersion of GO in seawater becomes an issue because of the GO layers may crosslink and form precipitates when exposed to di-valent cations, such as Ca²⁺, which are present in cement. FIG. 3 shows the GO dispersion in seawater, and GO precipitates at the bottom of the vial.

To address this issue, the present inventors added 0.5-1 wt. % of acrylic acid (as a dispersant) to the seawater. Acrylic acid can prevent the di-valent cations from crosslinking the GO layers through steric effect. FIG. 4 shows the stabilizing effect of acrylic acid on the GO dispersion (left beaker). Without acrylic acid, GO immediately precipitates out from seawater after mixing. See FIG. 3 and right beaker in FIG. 4.

### Example 2—Form Stability Tests

The form half-life in both DI water and seawater were tested when GO was used as the form stabilizer. Table 1 below shows the design of the form half-life test. The calculation was based on 427 g of cement. 1 wt % of prehydrated GO in DI water was used in this experiment. The total volume of the water was kept constant at 157 g (including the water in GO).

TABLE 1
Design for foam half-life test in GO

| Material | Purpose | Concentration | Mass (g) |
|---|---|---|---|
| Deionized Water or | | | 157.00 |
| Seawater | | | |
| Graphene Oxide (1 wt. %) | Foam Stabilizer | 0.005-0.1% | 2.14-42.7 |
| | | BWOC | |
| Ammonium C6-C10 | Foaming Agent | 0.10 gal/sk | 3.824 |
| alcohol ethoxylate | | (8.87 mL/kg) | |
| solution | | | |

According to API procedure (“API RP 10B-4: Recommended Practice on Preparation and testing of Formed Cement Slurries at Atmospheric Pressure”), form stability tests are performed by pouring 1 cm³ of surfactant solution in 100 cm³ of water to make the base slurry. The form mixture is then blended at 12,000 rpm in a Waring blender for one minute, and then poured in a 1000 cm³ graduated cylinder where it should occupy at least a volume of 600 cm³. The half-life (defined herein as the time it takes for 50 cm³ of liquid to form at the bottom of the form column) should be longer than six (6) minutes for the form to be considered stable.

However, the experimental procedure used herein was altered from the one described above to be more representative of the system. The base slurry (water+additives) was made using the same concentrations to form a formed cement. The present inventors believed that by using the same amount of additives, the effect of GO on form stability would be more readily apparent.

Furthermore, the mixing for this experiment was performed using a glass Waring blender cup. While mixing 157 g of water at low shear rate (1,000±100 rpm) for 60 seconds, the GO and ammonium alcohol ethoxylate surfactant solution were added (these two being pre-mixed using a stir bar at 500 rpm for 5 min). The shear rate was then increased to 12,000 rpm for 20 seconds. The resulting form was transferred to a 1,000 mL graduated cylinder. The half-life was determined to be the time to obtain ˜80 mL of liquid at the bottom of the form column (see FIG. 2a). Attention was also paid to the form column in terms of general stability and bubble size.

Deionized (DI) Water

Five different concentrations of GO (Examples 2a-2e) were tested, with the results being summarized in Table 2. Two additional formed slurries (Comparative Example 2a and Comparative Example 2b) were made for comparison. The slurries were prepared and evaluated in the exact same manner as described above except the slurry contained no stabilizer (Comparative Example 2a) or the GO form stabilizer was substituted with a proprietary aqueous mixture of polyglycols, oxyalkylates and alcohols (Comparative Example 2b).

TABLE 2
Foam Half-Life Result Summary for Deionized Water

| | | Comp. | | | | | |
|---|---|---|---|---|---|---|---|
| | | Ex. 2b | | | | | |
| | Comp. | (0.1 gal/sk | | | | | |
| Sample | Ex. 2a | (8.87 mL/kg)) | Ex. 2a | Ex. 2b | Ex. 2c | Ex. 2d | Ex. 2e |
| GO concentration | — | — | 0.005 | 0.01 | 0.02 | 0.05 | 0.1 |
| (% BWOC) | | | | | | | |
| Half-life (s) | 374 | 415 | 386 | 418 | 433 | 517 | 587 |
| Foam volume | 710 | 750 | 720 | 920 | 970 | 990 | 990 |
| after 20 | | | | | | | |
| min (mL) | | | | | | | |

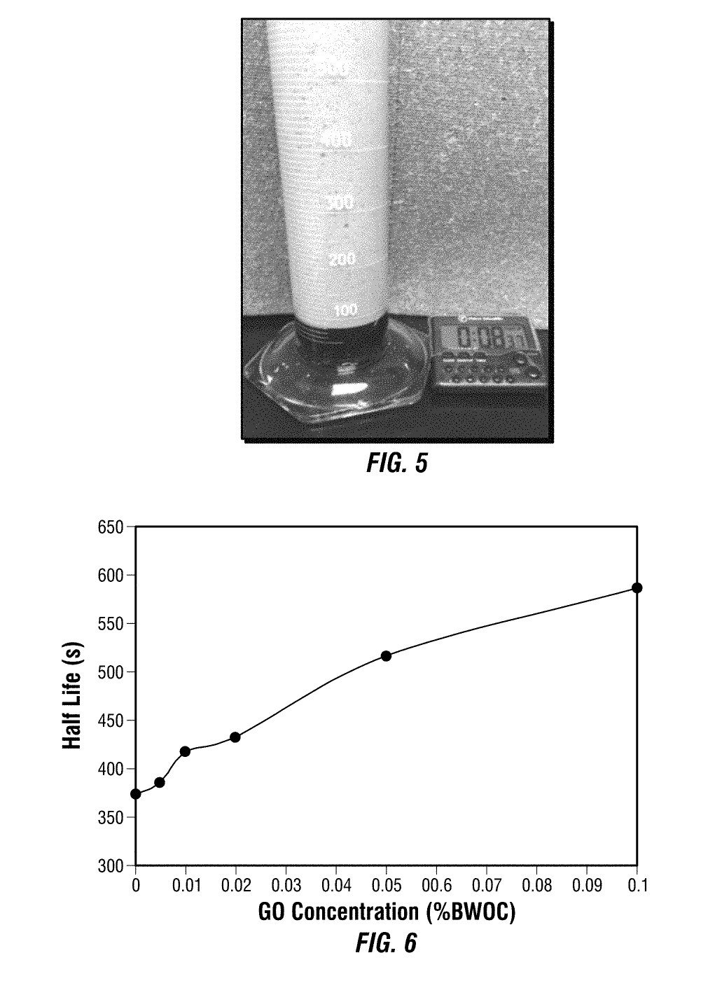

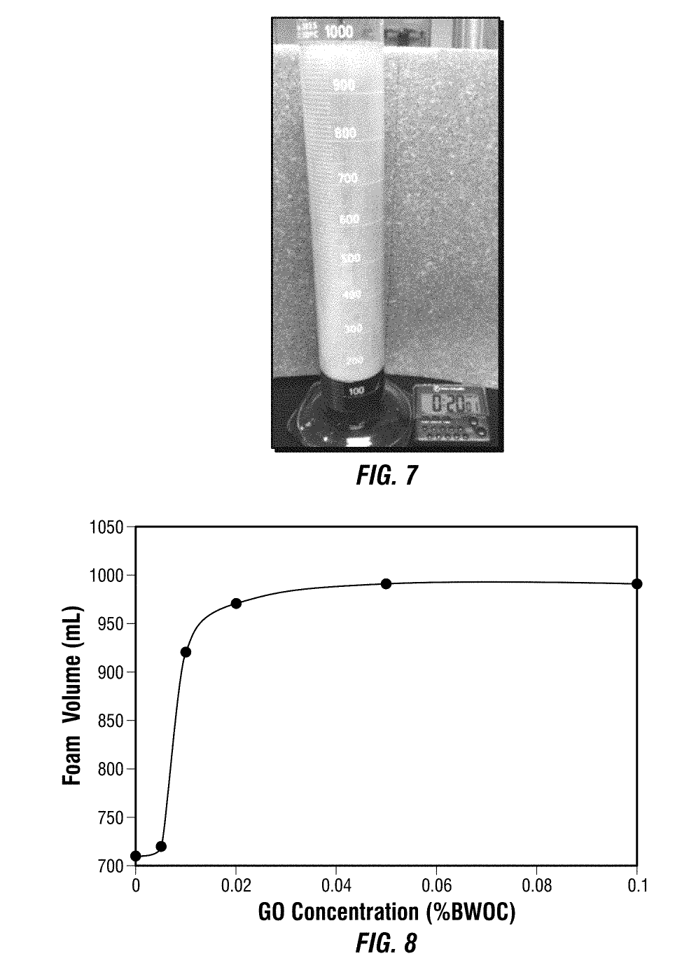

As shown in FIGS. 5-6 and above in Table 2, increasing the concentration of GO substantially improved the form half-life in DI water. In terms of the form volume over time, the form volume within the gradual cylinder was recorded 20 min after formation. FIGS. 7-8 illustrate that the stability of the form volume increase as more GO was added into the form. More specifically, with 0.05% BWOC of GO, the form volume changed slightly from its original volume (1000 mL) in 20 min. See Ex. 2e. However, the form volume decreased to 710 mL in 20 min when no GO was added into the form. See Comp. Ex. 2a. As for the size of the bubble, it was difficult to measure, but large bubbles were not observed before or after GO was added. Based on these two tests, GO was considered a suitable form stabilizer in DI water.

Seawater—No Acrylic Acid

As discussed above, the form half-life was also tested in seawater. Because GO cannot be easily dispersed in seawater, the present inventors performed two different methodologies to address this issue. First, GO was pre-mixed with an ammonium alcohol ethoxylate surfactant, which the present inventors believed prevents the GO from reacting with the cations in the seawater. However, this approach prevented the GO from reacting for a short period of time (˜5 min), as it eventually precipitated out. Regardless, this approach may work well in the form or cement system because once GO is properly dispersed at the initial mixing with the aid of surfactant, they are embedded within the bubbles or cement particles, which prevent it from aggregation.

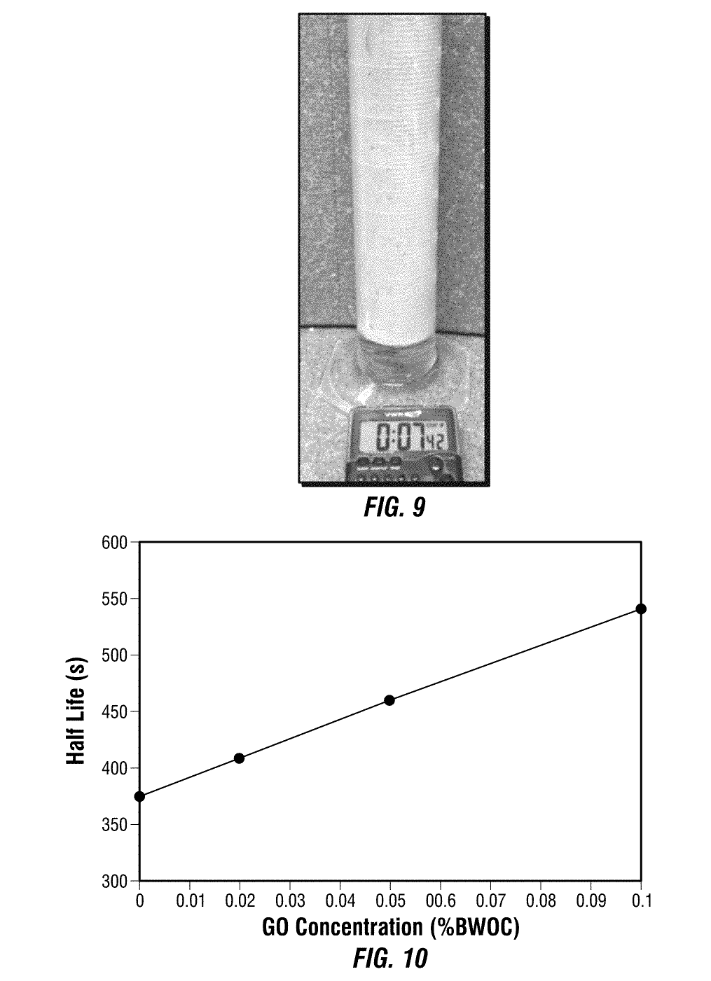

The procedure for this experiment (seawater) was the same as the procedure described above for DI water. The half-life results are shown in FIGS. 9-10 and Table 3 below. Three different concentrations of GO (Examples 2f-2h) were tested with the results being summarized in Table 3. Two additional formed slurries (Comparative Example 2c and Comparative Example 2d) were made for comparison. The slurries were prepared and evaluated in the exact same manner as described above except the slurry contained no stabilizer (Comparative Example 2c) or the GO form stabilizer was substituted with a proprietary aqueous mixture of polyglycols, oxyalkylates and alcohols (Comparative Example 2d).

TABLE 3
Foam Half-Life Result Summary for Seawater

| | | Comp. | | | |
|---|---|---|---|---|---|
| | | Ex. 2d | | | |
| | Comp. | (0.1 gal/sk | | | |
| Sample | Ex. 2c | (8.87 mL/kg)) | Ex. 2f | Ex. 2g | Ex. 2h |
| GO concentration | — | — | 0.02 | 0.05 | 0.1 |
| (% BWOC) | | | | | |
| Half-life (s) | 375 | 393 | 409 | 460 | 541 |
| Foam volume | 775 | 650 | 800 | 975 | 990 |
| after 20 | | | | | |
| min (mL) | | | | | |

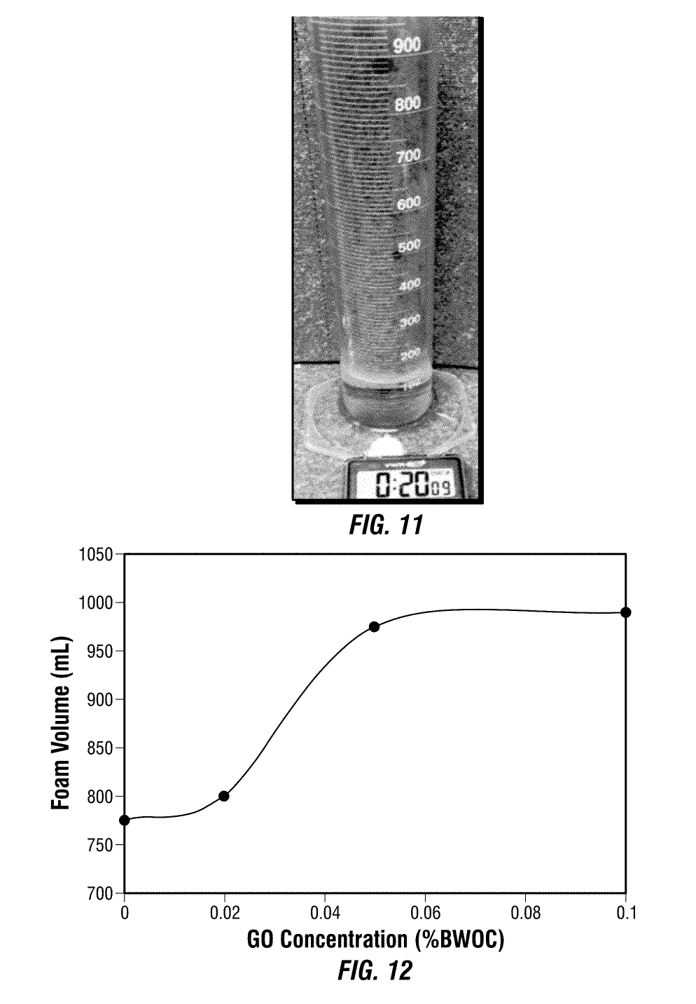

Similar to DI water above, the increased concentration of GO improved the form half-life. However, the improvement was not as significant as that of the DI water. The present inventors believe this may be due to the remaining amount of partially unwrapped GO that was exposed to the seawater and thus crosslinked with the cations of the seawater. The form volume after 20 min was also recorded and is shown in FIGS. 11-12. Similar to the results for DI water, GO was also proved to be a suitable form stabilizer for seawater.

Seawater—Acrylic Acid

The second approach included the addition of acrylic acid to seawater, which dramatically improved the GO dispersion. More specifically, 0.1 gal/sk of acrylic acid was added and mixed with the seawater before introducing premixed surfactant and GO mixture.

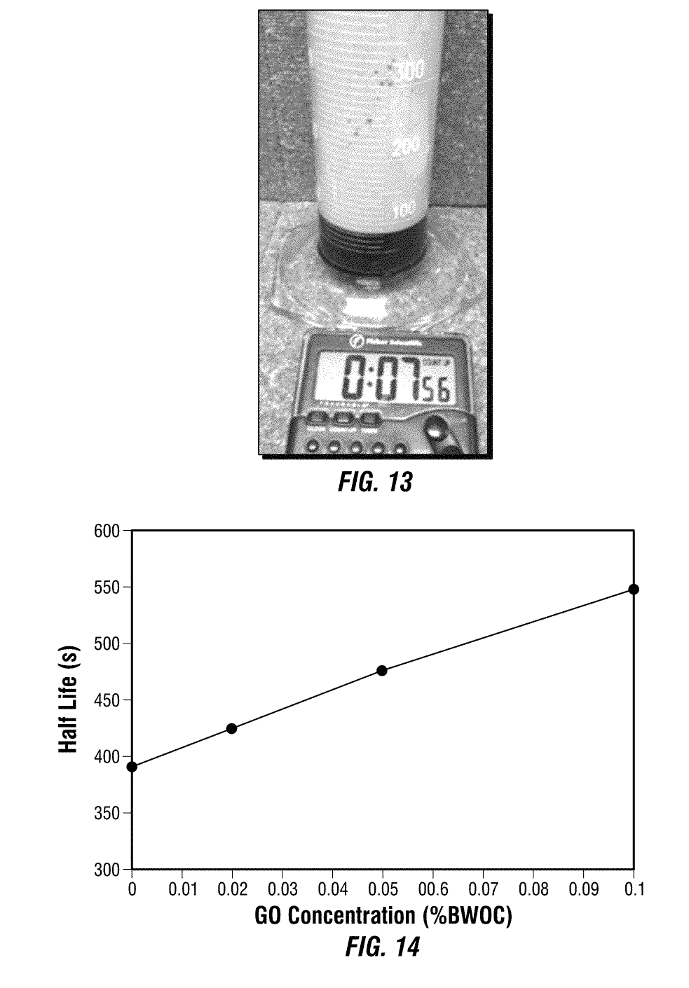

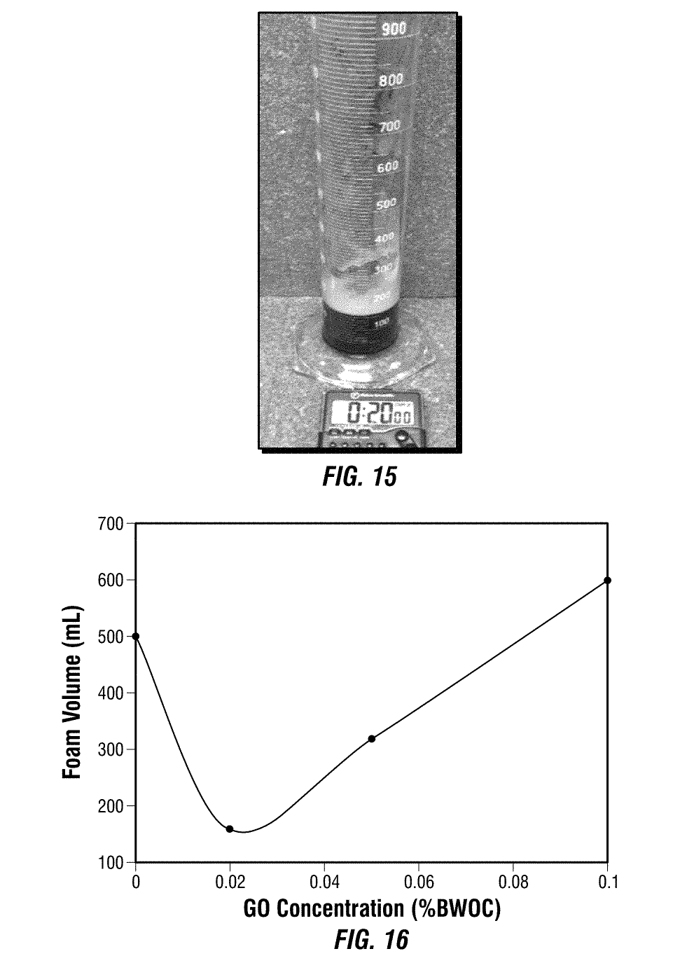

The half-life test results are illustrated in FIGS. 13-14, which shows that the half-life was negligibly improved when compared with the seawater embodiment without acrylic acid. However, unexpectedly the form volume after 20 min was dramatically decreased when arylic acid was added (FIGS. 15-16). Without acrylic acid, GO remained in the form and the bottom of the graduate cylinder had a clear solution (FIG. 7). However, GO remained in the water phase when acrylic acid was added and a brown solution was observed at the bottom of the graduate cylinder in FIG. 15. This phenomenon might explain why acrylic acid decreased the form stability since GO no longer sits at the interfaces between bubbles.

### Example 3—Sedimentation Test and Pore Size Distribution for Formed Cement

After the evaluation of GO as form stabilizer in both DI water and seawater exhibited promising results, GO was added to a cement slurry (Example 3) to form formed cement. Table 4 below details the components and amounts of various materials in the formed cement slurry of Example 3. This design represents a harsh environment for GO application (seawater having a high pH) and could thus be suitable for application in the Gulf of Mexico.

TABLE 4
Example 3 Foamed Cement Composition

| | | |
|---|---|---|
| Material | Function | Concentration |

Dry Phase Contents

| | | | |
|---|---|---|---|
| Lehigh H | Cement Blend | | |
| Potassium Chloride | Salt | 1.800 | lb/sk |
| | | (1.9 | wt %) |

Wet Phase Contents

| Seawater | Base Fluid | | |
|---|---|---|---|
| Acrylic Acid | Dispersant | 0.100 | gal/sk |
| | | (8.87 | mL/kg) |
| Polyvinyl Alcohol (PVA) | Fluid Loss Additive | 0.400 | gal/sk |
| | | (35.48 | mL/kg) |
| Graphene Oxide (1 wt. %) | Foam Stabilizer | 0.05% BWOC | |
| Alcohol ethoxylate | Foaming Agent | 0.100 | gal/sk |
| | | (8.87 | mL/kg) |
| Sodium Silicate | Extender | 0.200 | gal/sk |
| | | (17.74 | mL/kg) |

The formed cement described above in Table 4 was generated using the methods described in “API RP 10B-4: Recommended Practice on Preparation and testing of Formed Cement Slurries at Atmospheric Pressure”.

The formed cement slurry was evaluated by pouring the slurry into a PVC pipe having a diameter of 50.8 mm and 101.6 mm in height with a sealable top. and allowed to set in a vertical position for 24 hours at room temperature. The set cement was then cut into 8 small pieces with the top and bottom portions being discarded. The density of the remaining 6 pieces was measured using the following method. First, the mass of each section in air and in water was determined as as follows. A beaker of fresh water was placed on a balance and tared to a balance of zero. A section was then placed on the balance beside the beaker, with the mass of the section recorded and removed from the balance. Next, the balanced was tared again to zero and a noose of thin line was wrapped around the section. The section was then picked up by the line and suspended the water-containing beaker such that the sample was totally immersed in water and did not touch the bottom or sides of the beaker. The mass of the immersed section was then obtained as quickly as possible to prevent excessive water absorption. The sample was removed from the water and the above procedure was repeated for the remaining 5 sections. The density for each section was then calculated using Archimedes Principle (density=Mₐ/M_{w}, where Mₐ is the mass of the sample in air, expressed in grams and M_{w} is the mass of the sample in water, expressed in grams).

Two additional formed slurries (Comparative Example 3a and Comparative Example 3b) were made for comparison. The slurries were prepared and evaluated in the exact same manner as described above for Example 3 except that the GO form stabilizer was either substituted with a proprietary aqueous mixture of polyglycols, oxyalkylates and alcohols (Comparative Example 3a) or the slurry contained no stabilizer (Comparative Example 3b). The three slurries were designed to be 30% FQ, but because the measured slurry density was slightly off target, the FQ for each was adjusted accordingly. Further, because the slurries each had a density of 16.4 ppg, the target density was 11.48 ppg. The sedimentation test results for the three slurries are summarized below in Table 5.

TABLE 5
Sedimentation Test Results

| | | | Comparative | | Comparative | |
|---|---|---|---|---|---|---|
| | Example 3 | | Example 3a | | Example 3b | |
| Target Density | 11.48 | ppg | 11.48 | ppg | 11.48 | ppg |
| | (1.38 | g/mL³) | (1.38 | g/mL³) | (1.38 | g/mL³) |
| Measured Slurry | 11.38 | ppg | 11.43 | ppg | 11.30 | ppg |
| Density | (1.36 | g/mL³) | (1.37 | g/mL³) | (1.35 | g/mL³) |
| Foam Quality | 31.6% | | 30.3% | | 31.1% | |
| Cured Cement | 11.47 | ppg | 11.60 | ppg | 11.51 | ppg |
| Density by | (1.37 | g/mL³) | (1.39 | g/mL³) | (1.38 | g/mL³) |
| Section Top | 11.48 | ppg | 11.62 | ppg | 11.54 | ppg |
| to Bottom | (1.38 | g/mL³) | (1.39 | g/mL³) | (1.38 | g/mL³) |
| | 11.49 | ppg | 11.62 | ppg | 11.53 | ppg |
| | (1.38 | g/mL³) | (1.39 | g/mL³) | (1.38 | g/mL³) |
| | 11.52 | ppg | 11.61 | ppg | 11.54 | ppg |
| | (1.38 | g/mL³) | (1.39 | g/mL³) | (1.38 | g/mL³) |
| | 11.50 | ppg | 11.68 | ppg | 11.52 | ppg |
| | (1.38 | g/mL³) | (1.40 | g/mL³) | (1.38 | g/mL³) |
| | 11.52 | ppg | 11.67 | ppg | 11.56 | ppg |
| | (1.38 | g/mL³) | (1.40 | g/mL³ | 1.39 | g/mL³ |

| | | | |
|---|---|---|---|
| Greatest Percent | 1.23 | 2.19 | 2.30 |
| Deviation | | | |
| from Measured | | | |
| Slurry Density | | | |

As shown above in Table 5, by comparing the cement section density from top to bottom, once can see that the differences between each section were small and apparent sedimentation could not be readily detected via a visual inspection. However, according to the API requirement discussed above, the greatest percent deviation from measured slurry density is one of the suitable parameters for formed cement in sedimentation test. Those values were calculated and are displayed at the bottom of Table 3. Specifically, Comparative Example 3b (having the proprietary aqueous mixture stabilizer) had a 2.19% deviation. The deviation increased to 2.30% when the stabilizer was removed (Comparative Example 3a). However, the deviation was unexpectedly decreased to 1.23% when GO was used as the form stabilizer (Example 3).

The stability of the formed cement was also characterized by measuring the size of the pores within the cement matrix. Large pores having a wide size distribution should be avoided in cementing design since these may increase gas migration and degrade the mechanical properties of the cement. However, stable formed cement has small pores with uniform size distribution.

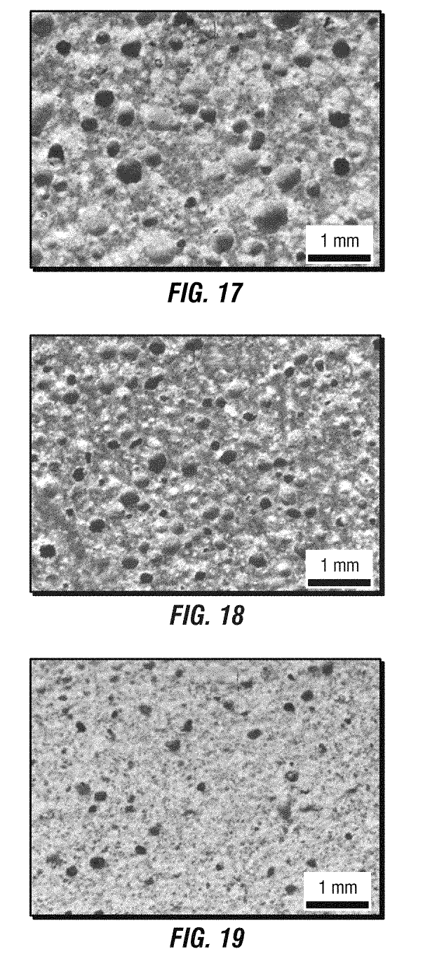

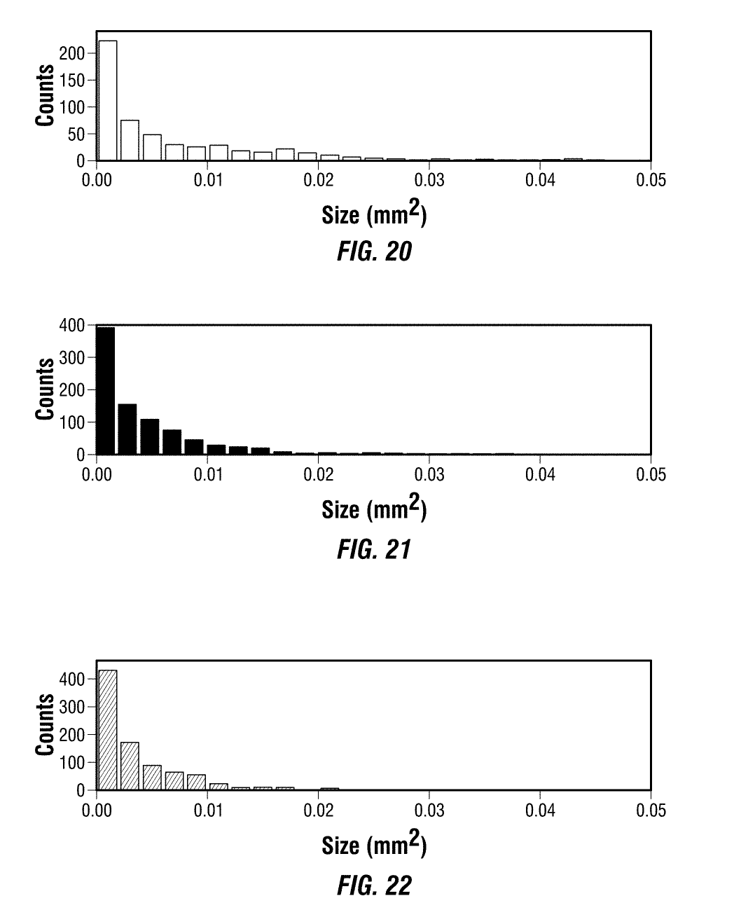

FIGS. 17-19 shows the optical microscope images of different formed cement samples with 30% FQ—samples corresponding to Example 3, and Comparative Examples 3a and 3b. The images were taken with a Leica DMS1000 Stereo Microscope and the size was processed using Image J software. The corresponding histograms for these cement samples are shown in FIGS. 20-22. Each histogram is based on 8 different microscope images. Furthermore, since the pores have an irregular shape, the pore area was reported as the result. A pore with 0.001 mm² roughly equals to a circular pore with 35 micron in diameter. Pores with sizes smaller than 0.001 mm² were disregarded due to the big error from Image J.

Specifically, FIG. 17 shows the size of the pores for the cement slurry without any stabilizer (Comparative Example 3b and Comparative Example 3a, respectively). The black dots in the image are pores formed from the bubbles. See FIG. 18. The largest pore observed was around 0.049 mm², and the average size was roughly 7.34×10⁻³ mm². See FIG. 20. When the proprietary stabilizer (Comparative Example 3a) was added, the pore size distribution improved, the average size being about 4.59×10⁻³ mm². See FIG. 21. Furthermore, the addition of GO as a form stabilizer (Example 3) resulted in an unexpectedly improved uniform size distribution as shown in FIG. 10b. The calculated average size was about 3.50×10⁻³ mm² (See FIG. 22), which is less than the average size for Comparative Examples 3a and 3b.

Based on the above two characterizations, the present inventors have unexpectedly demonstrated that GO can act as an effective form stabilizer for formed cement applications with better performance some of the conventional materials employed today.

In view of the entirety of the present disclosure, including the figures and the claims, a person having ordinary skill in the art will readily recognize that the present disclosure introduces a method comprising: preparing a cement composition comprising an aqueous fluid, inorganic cement, a foaming agent, a gas generating agent, and a stabilizer composition comprising graphene oxide; placing the cement composition in a subterranean well; and allowing the composition to set and form a set cement, wherein the presence of the graphene oxide results in the set cement having a greatest percent deviation from a measured slurry density of less than about 1.5%.

The aqueous fluid may be selected from the group consisting of fresh water, seawater, brine containing organic and/or inorganic dissolved salts, liquid containing water-miscible organic compounds, and combinations thereof. For example, the aqueous fluid may be brine and the cement composition may further comprise a dispersant. The dispersant may comprise acrylic acid.

The inorganic cement may be selected from the group consisting of Portland cement, calcium aluminum cement, fly ash, a lime-silica mixture, cement kiln dust, magnesium oxychloride, zeolite, blast furnace slag, geopolymer, chemically bonded phosphate ceramic or cations thereof, and combinations thereof.

The gas generating agent may be an inert gas. The gas generating agent may be selected from the group consisting of azodicarbonamide, oxy-bis-benzene sulfonylhydrazide, toluenesulfonyl-hydrazide, benzenesulfonyl-hydrazide, toluenesulfonyl-semicarbazide, 5-phenyltetrazole, ammonium nitrite, diazoaminobenzene, 2,2′-asobixisobutyronitrile, 1,1′-azobiscyclohexanecarbonitrile, hydrazine salt, N—N′-dimethyl-N,N′-dinitrosoterephthalamide, an ammonium C6-C10 alcohol ethoxysulfate and combinations thereof.

The present disclosure also introduces a cement composition comprising: aqueous fluid; inorganic cement; a foaming agent; a gas generating agent; and a stabilizer composition comprising graphene oxide.

The aqueous fluid may be selected from the group consisting of fresh water, seawater, brine containing organic and/or inorganic dissolved salts, liquid containing water-miscible organic compounds, and combinations thereof. For example, the aqueous fluid may be brine and the cement composition may further comprise a dispersant. The dispersant may comprise acrylic acid.

The inorganic cement may be selected from the group consisting of Portland cement, calcium aluminum cement, fly ash, a lime-silica mixture, cement kiln dust, magnesium oxychloride, zeolite, blast furnace slag, geopolymer, chemically bonded phosphate ceramic or cations thereof, and combinations thereof.

The gas generating agent may be an inert gas. The gas generating agent may be selected from the group consisting of azodicarbonamide, oxy-bis-benzene sulfonylhydrazide, toluenesulfonyl-hydrazide, benzenesulfonyl-hydrazide, toluenesulfonyl-semicarbazide, 5-phenyltetrazole, ammonium nitrite, diazoaminobenzene, 2,2′-asobixisobutyronitrile, 1,1′-azobiscyclohexanecarbonitrile, hydrazine salt, N—N′-dimethyl-N,N′-dinitrosoterephthalamide, an ammonium C6-C10 alcohol ethoxysulfate, and combinations thereof.

The present disclosure also introduces a method comprising: preparing a mixture comprising an aqueous fluid, inorganic cement, a foaming agent, a gas generating agent, and a stabilizer composition comprising graphene oxide; and shearing the mixture until the slurry is homogeneous, thereby forming a cement slurry.

The aqueous fluid may be selected from the group consisting of fresh water, seawater, brine containing organic and/or inorganic dissolved salts, liquid containing water-miscible organic compounds, and combinations thereof. For example, the aqueous fluid may be brine and the cement composition may further comprise a dispersant. The dispersant may comprise acrylic acid.

The inorganic cement may be selected from the group consisting of Portland cement, calcium aluminum cement, fly ash, a lime-silica mixture, cement kiln dust, magnesium oxychloride, zeolite, blast furnace slag, geopolymer, chemically bonded phosphate ceramic or cations thereof, and combinations thereof.

The gas generating agent may be an inert gas and/or a material selected from the group consisting of azodicarbonamide, oxy-bis-benzene sulfonylhydrazide, toluenesulfonyl-hydrazide, benzenesulfonyl-hydrazide, toluenesulfonyl-semicarbazide, 5-phenyltetrazole, ammonium nitrite, diazoaminobenzene, 2,2′-asobixisobutyronitrile, 1,1′-azobiscyclohexanecarbonitrile, hydrazine salt, N—N′-dimethyl-N,N′-dinitrosoterephthalamide, an ammonium C6-C10 alcohol ethoxysulfate, and combinations thereof.

Although the preceding description has been described herein with reference to particular means, materials and embodiments, it is not intended to be limited to particulars disclosed herein; rather, it extends to all functionally equivalent structures, methods and uses, such as are within the scope of the appended claims.

The Abstract at the end of this disclosure is provided to comply with 37 C.F.R. § 1.72(b) to permit the reader to quickly ascertain the nature of the technical disclosure. It is submitted with the understanding that it will not be used to interpret or limit the scope or meaning of the claims.

What is claimed is:

1. A method comprising:
preparing a cement composition comprising an aqueous fluid, inorganic cement, a foaming agent, a gas generating agent, and a stabilizer composition comprising graphene oxide;
placing the cement composition in a subterranean well; and
allowing the composition to set and form a set cement, wherein the presence of the graphene oxide results in the set cement having a greatest percent deviation from a measured slurry density of less than about 1.5%.

2. The method of claim 1, wherein the aqueous fluid is selected from the group consisting of fresh water, seawater, brine containing organic and/or inorganic dissolved salts, liquid containing water-miscible organic compounds, and combinations thereof.

3. The method of claim 1, wherein the aqueous fluid is brine and the cement composition further comprises a dispersant.

4. The method of claim 3, wherein the dispersant comprises acrylic acid.

5. The method of claim 1, wherein the inorganic cement is selected from the group consisting of Portland cement, calcium aluminum cement, fly ash, a lime-silica mixture, cement kiln dust, magnesium oxychloride, zeolite, blast furnace slag, geopolymer, chemically bonded phosphate ceramic or cations thereof, and combinations thereof.

6. The method of claim 1, wherein the gas generating agent is an inert gas.

7. The method of claim 1, wherein the gas generating agent is selected from the group consisting of azodicarbonamide, oxy-bis-benzene sulfonylhydrazide, toluenesulfonyl-hydrazide, benzenesulfonyl-hydrazide, toluenesulfonyl-semicarbazide, 5-phenyltetrazole, ammonium nitrite, diazoaminobenzene, 2,2′-asobixisobutyronitrile, 1,1′-azobiscyclohexanecarbonitrile, hydrazine salt, N—N′-dimethyl-N,N′-dinitrosoterephthalamide, an ammonium C₆-C₁₀ alcohol ethoxysulfate, and combinations thereof.

8. A cement composition comprising:
an aqueous fluid;
an inorganic cement;
a foaming agent;
a gas generating agent; and
a stabilizer composition comprising graphene oxide.

9. The cement composition of claim 1, wherein the aqueous fluid is selected from the group consisting of fresh water, seawater, brine containing organic and/or inorganic dissolved salts, liquid containing water-miscible organic compounds, and combinations thereof.

10. The cement composition of claim 9, wherein the aqueous fluid is brine and the cement composition further comprises a dispersant.

11. The cement composition of claim 10, wherein the dispersant comprises acrylic acid.

12. The cement composition of claim 8, wherein the inorganic cement is selected from the group consisting of Portland cement, calcium aluminum cement, fly ash, a lime-silica mixture, cement kiln dust, magnesium oxychloride, zeolite, blast furnace slag, geopolymer, chemically bonded phosphate ceramic or cations thereof, and combinations thereof.

13. The cement composition of claim 8, wherein the gas generating agent is an inert gas.

14. The cement composition of claim 8, wherein the gas generating agent is selected from the group consisting of azodicarbonamide, oxy-bis-benzene sulfonylhydrazide, toluenesulfonyl-hydrazide, benzenesulfonyl-hydrazide, toluenesulfonyl-semicarbazide, 5-phenyltetrazole, ammonium nitrite, diazoaminobenzene, 2,2′-asobixisobutyronitrile, 1,1′-azobiscyclohexanecarbonitrile, hydrazine salt, N—N′-dimethyl-N,N′-dinitrosoterephthalamide, an ammonium C₆-C₁₀ alcohol ethoxysulfate, and combinations thereof.

15. A method comprising:
preparing a mixture comprising an aqueous fluid, inorganic cement, a foaming agent, a gas generating agent, and a stabilizer composition comprising graphene oxide; and
shearing the mixture until the slurry is homogeneous, thereby forming a cement slurry.

16. The method of claim 15 wherein the aqueous fluid is selected from the group consisting of fresh water, seawater, brine containing organic and/or inorganic dissolved salts, liquid containing water-miscible organic compounds, and combinations thereof.

17. The method of claim 16 wherein the aqueous fluid is brine and the cement composition further comprises a dispersant.

18. The method of claim 17 wherein the dispersant comprises acrylic acid.

19. The method of claim 15 wherein the inorganic cement is selected from the group consisting of Portland cement, calcium aluminum cement, fly ash, a lime-silica mixture, cement kiln dust, magnesium oxychloride, zeolite, blast furnace slag, geopolymer, chemically bonded phosphate ceramic or cations thereof, and combinations thereof.

20. The method of claim 15 wherein the gas generating agent is an inert gas or a material selected from the group consisting of azodicarbonamide, oxy-bis-benzene sulfonylhydrazide, toluenesulfonyl-hydrazide, benzenesulfonyl-hydrazide, toluenesulfonyl-semicarbazide, 5-phenyltetrazole, ammonium nitrite, diazoaminobenzene, 2,2′-asobixisobutyronitrile, 1,1′-azobiscyclohexanecarbonitrile, hydrazine salt, N—N′-dimethyl-N,N′-dinitrosoterephthalamide, an ammonium C₆-C₁₀ alcohol ethoxysulfate, and combinations thereof.
